(19) United States
(12) Patent Application Publication
(10) Pub. No.: US 2006/0028582 A1
(43) Pub. Date: Feb. 9, 2006

(54) Peripheral device for a television set

(76) Inventor: Matthias Zahn, Munich (DE)

Correspondence Address: EDELL, SHAPIRO & FINNAN, LLC, 1901 RESEARCH BOULEVARD, SUITE 400, ROCKVILLE, MD, 20850, US

(21) Appl. No.: 11/200,235

(22) Filed: Aug. 10, 2005

Related U.S. Application Data
(63) Continuation of application No. PCT/DE04/00239, filed on Feb. 10, 2004.

(30) Foreign Application Priority Data
Feb. 10, 2003 (DE) DE 103 05 561.4
Apr. 29, 2003 (DE) DE 103 19 292.1

(51) Int. Cl. H04N 7/18; H04N 7/173; H04N 7/16; H04N 7/00; H04N 11/00

(52) U.S. Cl. 348/552; 725/80; 725/133; 725/141; 725/153

(57) ABSTRACT

A parallel, nearly simultaneous transmission channel simulates real-time interactive capability from a television station to a viewer in a peripheral device for a television set including an interface at which the television signal can be picked up. The peripheral device is provided with a plug-in device for connecting the peripheral device to the interface of the television set or an additional interface that is connected to the television set. At least one portion of the television signal applied to the one interface or the additional interface is processed by a processing device of the peripheral device while the data supplied by the processing device is transmitted to a receiver unit via a transmitter unit of the peripheral device.

### CROSS REFERENCE TO RELATED APPLICATIONS

This application is a continuation of PCT/DE2004/000239, filed Feb. 10, 2004, and titled “Peripheral Device for a Television Set,” which claims priority to German Application No. DE 103 05 561.4, filed Feb. 10, 2003, and titled “Peripheral Device for a Television Set”, and to German Application No. DE 103 19 292.1, filed on Apr. 20, 2003, and titled “Peripheral Device for a Television Set,” the entire contents of each are hereby incorporated by reference.

### FIELD OF THE INVENTION

The present invention relates to a peripheral device or accessory unit for a television set comprising an interface at which the television signal can be tapped off. Furthermore, the present invention relates to a receiver device that cooperates with the peripheral device. Finally, the invention relates to a corresponding system having a peripheral device and a receiver device.

### SUMMARY

The invention avoids disadvantages of the prior art and, in particular, provides an optional, parallel and nearly simultaneous transmission channel simulating a real-time interactive capability from the television transmitter to a television viewer. A peripheral device has a plug-in device for connecting the peripheral device to the interface of the television set or a corresponding interface of a further peripheral unit, such as, e.g., a video recorder, connected to the television set, at least one portion of the television signal present at the one interface or the further interface being processed by a processing device of the peripheral device, and the data supplied by the processing device being transmitted to a receiver device via a transmission device of the peripheral device.

A particular advantage of the present invention is that, in the case of the transmission or communication and display of the program-accompanying additional data in accordance with the invention, the television picture is not disturbed or impaired; rather, it is presented unchanged on the television set, since the method according to the invention is a genuine optional additional service. It is not even necessary for there to be a program interruption, as occurs when switching over to teletext.

In an advantageous manner, the processing device extracts impressed additional data in addition to the program signal from the television signal and conditions them for the transmission. This extraction generally comprises the decoding and, if appropriate, the partial decryption of the additional data. The conditioning comprises the renewed coding for the transmission to the receiver device.

It is furthermore preferred for the impressed additional data to have the channel number of the set television transmitter (CNI) and/or the current time of day, in particular in encrypted fashion. The transmission of the current time of day in encrypted (no interception possible) and/or at least authenticated (the receiver device recognizes the transmitted time of day as correct and originating from the plug-in module) form in addition to the time of day that is already inherently transmitted with the television signal to the peripheral device according to the invention has the particular advantage that it is thereby possible to prevent a manipulation of the data transmission method according to the invention to the receiver device, which can preferably be used for prize games.

In an advantageous manner, the transmission of the data by the transmission device is exclusively unidirectional and is effected essentially simultaneously with the broadcast program signal to the receiver device. The unidirectional transmission is technically relatively easy to realize and the interactive capability is simulated by the type of transmitted data, e.g., question-answer. The simultaneity on the one hand ensures that undesirable manipulations are avoided, and on the other hand this is an advantage since a multiplicity of television viewers can be addressed simultaneously in a simple manner, which, e.g., in the case of a prize game, simplifies the prize distribution according to the law of large numbers.

In a particularly practical embodiment variant, the peripheral device furthermore has a socket device in which at least one further peripheral unit for the television set can be connected, the peripheral device being essentially transparent between plug-in and socket device. In this case, the further peripheral device is a video recorder or the like. This means that the interface of the television set is not blocked for other applications by the use of the peripheral device according to the invention.

Furthermore, it is preferred for the peripheral device to be formed as a plug-in module with a plug section and a socket section. The connection of the peripheral device according to the invention is made possible simply and reliably without any further space requirement through simple insertion of the plug-in module.

In an advantageous manner, the peripheral device draws the energy for its electrical supply from a portion of the electrical energy of one or more interface signals of the television signal. Consequently, the peripheral device does not require a power supply system connection or a battery and the like.

In this case, it is preferred for the transmission device to be formed as an RF transmitter (alternatively, e.g., IR connection or cable) which transmits the data supplied by the processing device as coded pulses in encrypted form to the receiver device. If the pulse-coded transmission has a correspondingly low duty cycle, it may have an extremely low power consumption. The encryption is particularly preferred in order to avoid undesirable manipulations and to preclude interception.

The invention is particularly advantageous in connection with that interface at which the television program currently set on the television set can be tapped off since the additional data channel provided according to the invention is received in program-accompanying fashion in parallel, without the television picture being impaired visibly to a user, with the current program. Consequently, it is also possible precisely to communicate additional information assigned to a currently set or tuned channel. In the event of a channel change of the television channel, corresponding information provided by the broadcasting company, such as, e.g., television transmitter, if present in this channel, is received in program-accompanying fashion with respect to the newly set channel. In a simple technical realization, the interface is the SCART connection of the television set or a further peripheral unit connected via the SCART connection of the television set. In this case, the peripheral device formed as a plug-in module is formed in such a way that the plug-in section is a SCART connector and the socket section is a SCART socket. It goes without saying that other interfaces, such as, e.g., a serial interface, are also taken into consideration for use with the present invention.

The further peripheral or accessory unit that cooperates with the peripheral device or plug-in module according to the invention is preferably a receiver device having a reception capability for data transmitted by the peripheral device, but under certain circumstances also having further transmission capabilities, e.g., to the peripheral device or for remote data transmission, the further peripheral or accessory device or the receiver device preferably being a portable unit comprising a display device for displaying data, an input device for inputting data and a processing device.

In order to simulate an interactive capability, it is preferred for the processing device of the peripheral device to extract from the television signal data which have two different sets of data, individual data of the two data sets being assigned to one another, assigned data of the two data sets being transmitted to the receiver device by the transmission device, and at least initially any data of the first data set being displayed on the display device of the receiver device, and the second group of data being used for the evaluation of data input by a user via the input device of the receiver device by the processing device of the receiver device.

For simple realization of chargeable additional services of interactive television, it is preferred for the receiver device to have an electronic cash device, an amount being debited in a case in which the evaluation reveals that the data input by the user do not correspond to the associated data of the second data set. Accordingly, any type of additional data such as, e.g., weather information, transmission-accompanying data, etc., can be received and displayed in exchange for the debiting of an amount.

The receiver device preferably has a loudspeaker via which data generated by the processing device are remotely transmitted via a telephone line. The use of the loudspeaker makes it possible to transmit an encrypted message, e.g., an identification of a prize in a prize game, via a telephone line in a simple manner and with sufficient security against manipulation.

Preferably, in order to start up the receiver device, it is necessary to input an authentication code in the manner of a mobile telephone in order to prevent unauthorized operation of the receiver device.

For security reasons, it is furthermore preferred for at least one part of the processing device of the receiver device to be formed as a smart card chip. In this case, the security-critical part of the data processing is carried out by the smart card chip. Other controls, e.g., the driving of the display, are realized by a conventional CPU.

Furthermore, the present invention relates to a plug-in module which can be inserted into an interface of a television set or into an interface of a peripheral unit connected thereto, the inserted plug-in module having a device for separating additional data impressed on the television signal present at the interface from said television signal, and the plug-in module furthermore having a transmission device for transmitting the additional data to a portable receiver device. In this case, a plug-in module denotes a structural unit which can be fixed to the interface by means of a simple plug-in operation and has a corresponding plug part for this purpose. Examples of corresponding peripheral devices are for instance a video recorder, a set-top box and the like. The preferably program-accompanying additional data are impressed on the program signal at the transmitter end, and transmitted in the blanking interval, for example, together with the television signal. The receiver device is portable and can be carried by a user.

In this case, it is preferred for the transmission of the additional data to be effected essentially simultaneously with the display of the program signal that is assigned for the currently tuned channel on the television set. A respective channel has corresponding additional data synchronized with the program signal at specific points in time. By virtue of the short period of time that elapses between the isolation of the additional data, the transmission to the receiver device and the display, it is possible to realize nearly simultaneous display of the additional data on the receiver device.

Preferably, the plug-in module receives additional data corresponding to the program signal currently being displayed on the screen of the television set via the interface. A parallel data transmission channel is produced in this way. On account of the correspondence of the additional data to the program signal, preference is given to the fact that, in the event of a channel switchover of the television set from a previous channel to a current channel, the additional data of the current channel are separated and transmitted after the switchover by the plug-in module via the interface.

In an advantageous manner, the interface is an interface formed externally on the television set, and more preferably a SCART interface of a television set or of a peripheral device. In this case, the additional data are received via “pin 19” of the SCART interface of a television set or “pin 20” of the SCART interface of a set-top box, video recorder or the like.

In order to enable a simultaneous and independent display of the program signal on the television set and the additional data, it is preferred for the portable receiver device to have a display device in which the additional data are displayed, in particular essentially simultaneously with the program signal displayed on the television set.

In a preferred embodiment, the portable receiver device is a mobile telephone, a personal digital assistant (PDA), e.g., palm computer, or the like. Via the Bluetooth interface or an IrDa data connection under certain circumstances in conjunction with further types of transmission, it is possible to realize the transmission path between the plug-in module and the mobile telephone, to be precise bidirectionally. In this case, an IrDa data connection denotes a standardized connection via an infrared interface such as is used in a known manner for communication between mobile telephones and notebooks. In the case of a Bluetooth connection, the communication is effected directly between the plug-in module and the mobile telephone. The fact that the plug-in module is generally inserted on the rear side of a television set is not an impediment in this case since this does not impair the Bluetooth transmission. In the case where an IrDa data connection is used, it is preferred for this to be used only on part of the transmission link from plug-in module to receiver device. This is due to the fact that the television set generally disturbs infrared communication with the plug-in module as a result of blocking the line of sight. Although that can be remedied, for example by using a cable to route an IR transceiver for communication with the receiver device around the television set, preference is given to a variant in accordance with which a first transmission link via RF from the plug-in module to an IrDa repeater is provided. The IrDa repeater to the receiver device, i.e., the mobile telephone and the like, then represents a second transmission link. In this case, the IrDa repeater is integrated for example in a receptacle element (cradle) or plug-in module for the receiver device. Consequently, a bidirectional communication with the plug-in module can be realized in a simple manner, and in particular without complicated changes to commercially available mobile telephones, PDAs and the like. In this exemplary embodiment, the bidirectionality of the data connection is advantageous because, by way of example, the evaluation of prize games is effected in the plug-in module and inputs by a user have to be transmitted to said module again. Instead of the explicitly mentioned Bluetooth or IrDa connection, it is possible to provide any type of a connection, in particular a wireless or wire-based communication connection.

In order not to block the SCART slot of the television set for further connections, it is preferred for the plug-in module to have a plug section and a socket section, the plug section and a socket section being arranged such that they are essentially opposite, and the plug-in module being formed such that it is essentially transparent between the plug section and a socket section. “Essentially transparent” is understood to mean a through-connection of the corresponding pins of the plug section and socket section which are necessary for most standard applications (connection of a video recorder to the socket section of the connector module, etc.).

Furthermore, the object according to the invention is achieved by means of a plug-in module which can be inserted into a SCART interface of a television set or in a SCART interface of a peripheral device connected thereto, the plug-in module reading additional data impressed on the television signal and, in particular via a unidirectional transmission link, transmitting them essentially simultaneously with the broadcast program signal to a portable receiver device. The invention likewise relates to a system comprising a peripheral device or a plug-in module and a receiver device. Finally, the invention relates to a method for providing a transmission channel in parallel with a television transmission by means of a plug-in module which can be inserted at a SCART interface of a television set or a peripheral device connected thereto, the plug-in module reading additional data impressed on the television signal and transmitting them via a unidirectional transmission link essentially simultaneously with the broadcast program signal to a portable receiver device.

### BRIEF DESCRIPTION OF THE DRAWINGS

Further preferred embodiments of the invention are disclosed in the dependent patent claims.

The invention and also further features, aims, advantages and application examples thereof are explained in more detail below on the basis of a description with reference to the accompanying drawings. Throughout the drawings the same reference symbols designate the same or corresponding elements. In this case, all features that are described and/or represented pictorially form the subject matter of the present invention by themselves or in any desired expedient combination, to be precise independently of their combination in the patent claims or the reference back thereof. In the drawings:

FIG. 1 shows a schematic illustration of an application of the present invention in conjunction with a home TV system;

FIG. 2a shows a schematic illustration for elucidating the operation of the system according to the invention comprising a plug-in module and a portable receiving unit in accordance with a first exemplary embodiment of the present invention, the receiving unit representing a dedicated hardware or an additional module for a mobile telephone, a PDA, a remote control, etc.;

FIG. 2b shows an illustration corresponding to FIG. 1a, the upper part of FIG. 1b showing the receiving unit in a first operating mode (question/answer), the middle part of FIG. 1b showing the receiving unit in a second operating mode (information operating mode) and the lower part of FIG. 1b showing the receiving unit in a third operating mode (electronic cash operating mode);

FIG. 2c shows a schematic illustration for elucidating the operation of the system according to the invention comprising a plug-in module and a portable receiving unit in accordance with a second exemplary embodiment of the present invention, the receiving unit being a mobile telephone;

FIG. 2d shows a schematic illustration in the form of a block diagram for elucidating the construction and the data transmission of the system according to the invention comprising a plug-in module and a portable receiving unit in accordance with a third exemplary embodiment of the present invention, the receiving unit being a mobile telephone;

FIG. 2e shows a schematic illustration for elucidating the operation of the system according to the invention comprising a plug-in module and a portable receiving unit in accordance with the second exemplary embodiment of the present invention, the receiving unit being a remote control for a television set;

FIG. 2f shows a schematic illustration in the form of a block diagram for elucidating the construction and the data transmission of the system according to the invention comprising a plug-in module and a portable receiving unit in accordance with the third exemplary embodiment of the present invention, the receiving unit being a remote control for a television set;

FIGS. 3a to 3f show different connection variants of the plug-in module according to the invention to a television set or further devices connected thereto;

FIG. 4 shows a schematic block diagram of the construction of the plug-in module according to the invention in accordance with the first exemplary embodiment of the present invention;

FIG. 5 shows a schematic block diagram of the construction of the receiving unit according to the invention in accordance with the first exemplary embodiment of the present invention;

FIG. 6 shows a schematic block diagram of the construction of the plug-in module according to the invention in accordance with the second exemplary embodiment of the present invention, the receiving unit being a mobile telephone; and

FIG. 7 shows a schematic block diagram of the construction of the plug-in module according to the invention in accordance with the second exemplary embodiment of the present invention, the receiving unit being a remote control for a television set.

### DETAILED DESCRIPTION

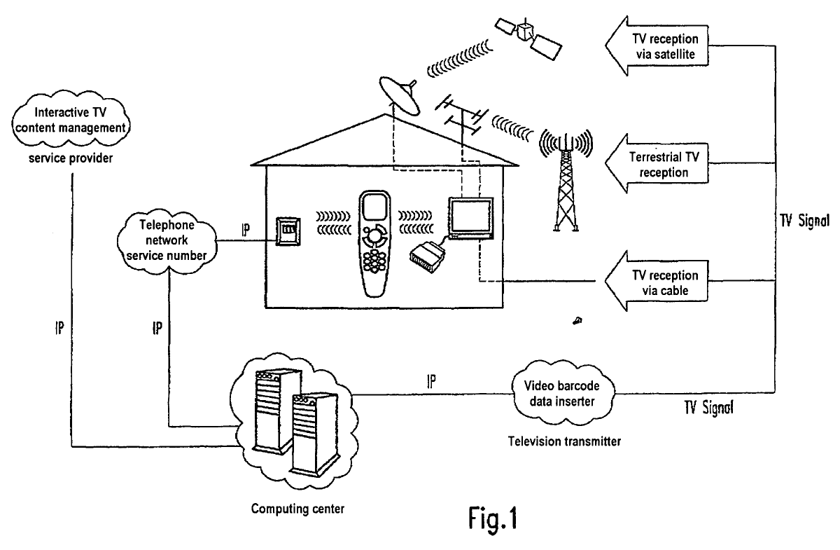

FIG. 1 illustrates the practical application of the present invention in the form of a schematic overview. The illustration reveals a preferably domestic TV receiving unit or television which can receive TV signals by various methods. Various transmission paths are indicated schematically in FIG. 1. More precisely, TV reception via satellite, terrestrial TV reception and TV reception via a cable network are shown. These transmission paths can be used either individually or in combination in connection with the present invention. The TV signals are broadcast by a television transmitter on the different transmission paths. Additional data impressed on the television signal are preferably transmitted together with the television signal to the television set.

A multiplicity of techniques are known for this purpose in the prior art. A particularly preferred possibility for impressing additional data with respect to the television signal is described in the German patent application No. 101 01 750.2 and entitled “Method for the transmission of data with a television signal” filed on Jan. 16, 2001, and the PCT publication WO 02/25924 A2, the entire disclosure of both documents being concomitantly incorporated by this reference in the present application. According to this method, the additional data are not incorporated in the blanking interval, which is the case for instance for conventional teletext, but rather in the video signal, that is to say in that part of the television signal which is displayed on the television set, in a manner not visible to the television viewer. Since this method is particularly preferred in connection with the present invention, this is described in greater detail below.

Various television standards are known in the prior art. Quite generally, a television signal is composed in particular of an actual video signal (V), the blanking signal (B), and the sync signal (S). In this case, the video signal has the information obtained line by line about the brightness distribution of a picture original to be transmitted. During the horizontal and vertical beam flyback, the video signal is interrupted in its temporal progression; it is as it were “blanked”. The blanking signal is formed by line-frequency horizontal blanking pulses and by vertical blanking pulses which appear with the rhythm of the field change and have a shorter duration than the horizontal blanking pulses. In order, at the receiving end, to enable the line raster written on the television picture tube to proceed synchronously with the line raster at the transmitting end, the sync signal is provided. It equally controls the deflection devices at the recording and reproduction converter. In addition, a chrominance signal is also transmitted in order to permit a compatible color picture transmission. For transmitting the accompanying sound, a frequency modulation of a high-frequency sound carrier oscillation is usually used in television broadcasting.

The television transmission that is known in accordance with the prior art takes up a broad and costly communication channel, but the latter is not fully utilized. For approximately a quarter of the transmission time no actual picture information, corresponding to the video signal defined above, is transmitted. The synchronizing information for the horizontal and vertical beam deflection is transmitted in the periodically occurring blanking intervals. Nevertheless, e.g., according to the CIR 625-line standard, 17 full lines which could be occupied by additional information still remain per field. However, in accordance with the prior art, only approximately twelve lines per field are occupied by test and data signals. This transmission of additional test and/or data signals is not manifested to the television viewer in a disturbing manner because they lie within the vertical blanking.

One example of a data signal of this type is teletext. Teletext affords a television subscriber the possibility of perceiving, in addition to the television program offered, information from particular areas by means of characters and graphics on the screen. The editorial conditioning is performed by the broadcasting corporations and institutions appointed by them. Examples of what is offered include current news, traffic indications, weather reports, sport information and the like. However, insertions in the current program such as, e.g., subtitles in the case of foreign language broadcasts, may likewise be performed as well.

Teletext has the disadvantage first of all that the possible quantity of data to be transmitted is limited. It would be desirable, therefore, if further possibilities were available, to transmit further information to the television receiver.

A further disadvantage of teletext consists in the fact that, for transmitting the known additional test or data signals, this complicated hardware and software, in the transmission studio, must be combined with the video signal to form the actual transmission signal. Therefore, the method for generating the transmission signal is relatively complicated since complicated synchronization has to be ensured, in part also manually, when combining the data signals with the actual “content.”

The method published in the PCT publication WO 02/25924 A2, which method provides a remedy with regard to the above disadvantages of teletext, is based on the central idea that a multiplicity of lines per field cannot be occupied by data signals for reasons of the tolerance margin. This is due to the fact that every television receiver has a so-called “cache” and thus makes only part of the active video signal visible to the user. Since the size of the cache differs depending on the design of the television set used, these intervals are not used for data transmission, in order not to adversely affect the viewing comfort of the television viewer. The central idea of this previously described method consists, however, precisely in overcoming this prejudice and indeed using these hitherto unused intervals for data transmission. The case in which picture reproduction is impaired for a television receiver with a correspondingly large cache is taken into account by the fact that the transmitted data are designed to be minimally invasive for the television picture.

A particular advantage here consists in the fact that the data to be transmitted are not transmitted in the blanking interval, but rather together with the video signal, that is to say the actual content. The studio conditioning of the television signal is thus simplified since separate synchronization does not have to be carried out. Likewise, the data can be transmitted independently of a transmitter in this way. By way of example, a commercial in or together with which data are transmitted according to the invention can supply the same information to a television receiver independently of the broadcasting transmitter.

In an advantageous manner, the data are transmitted in the actual video signal. In this way, the data are concomitantly recorded for any type of recording of the video signal, e.g., by means of a conventional video recorder, and are thus available in particular also during the reproduction of the recording. Therefore, additional information can likewise be supplied to a television viewer about whom one knows as it were that he is currently receiving a specific program signal since the information is transmitted in the picture.

The method published in the PCT publication WO 02/25924 A2 can be summarized as follows:

Method for the transmission of data together with a television signal which has a video signal and a blanking signal, the data being transmitted in a region lying between the last line or column occupied by test or data signals and a predetermined line or column of the video signal. In this case, it is preferred for the data to be transmitted in the video signal. In this case, it is preferred for the data to be transmitted in an edge region or both vertical edge regions of the video signal, in particular in the spatial arrangement in the manner of a column. In this case, it is preferred for the data to be linked into the video signal in the manner of a bar code in the edge region of the video signal. In this case, it is preferred for the line(s) or column(s) in which the data are transmitted to be fixedly predetermined. In this case, it is preferred for the signal to be a ternary signal. In this case, it is furthermore preferred for the television transmission signal to be formed by combining the signal containing the data to be transmitted, which has the video signal, and a separate blanking signal. In this case, it is preferred for the data to be coded in an Internet standard. In this case, it is preferred for the Internet standard to be SGML or a derivative thereof, in particular HTML or XML. In this case, it is preferred for the data to have text, graphics, images or programs and the like. In this case, it is preferred for the data to be transmitted in a region of the video signal which essentially corresponds to the cache of a television receiver or is essentially contained therein. In this case, it is preferred for the data to be incorporated in a region of the video signal which is suppressed by one or both vertical edge regions of the oval cache of the television receiver. Furthermore, it is preferred in this case for the data additionally to be transmitted in the blanking signal.

In principle, however, it is also possible for the additional data to be concomitantly transmitted in the video signal in some other way, for example using so-called water marking methods. However, it is likewise possible, in principle, for the additional data to be transmitted via teletext.

Referring to FIG. 1 again, the additional data which are preferably impressed on the television picture in the video signal in the form of a bar code are detected by a peripheral device for a television set, which is shown as a plug-in module in FIG. 1 and is inserted in the application in a SCART socket on the rear side of the television set, and are transmitted to a preferably portable, handheld receiver device. The SCART socket is particularly preferred in this case since, by this means, the video signal that is currently set on the television set is accessible externally—without disturbing the television set—and the TV tuner of the television set as it were operates for the method according to the invention. A remote control for the television set is preferred as the receiver device, said remote control being learning, that is to say programmable and usable for all types of television sets. The receiver device may also have other (main) functions, and may be, e.g., a mobile telephone or a PDA or an accessory unit therefor. Furthermore, the receiver device or remote control has various additional functions which are explained in more detail below and about which it will merely be mentioned at this juncture that the remote control can receive the additional data that are impressed on the video signal and detected by the peripheral device and present them on a display panel or display. Furthermore, the illustration of FIG. 1 reveals that a return channel is also provided, via which data can be sent back to a computing center from the receiver device via the telephone network, in particular the landline network. By means of the computing center, the additional data transmitted to the computing center by a service provider for content management for interactive television (TV) are also sent to the television transmitter for impressing the “video barcode” in the television signal. In this case, the data transmission is preferably effected by means of the Internet protocol (IP) as shown in FIG. 1.

It should also be pointed out at this juncture that the present invention is not restricted to tapping off the television or video signal via an interface, and in particular the SCART interface.

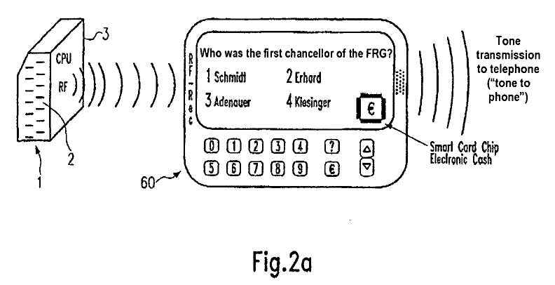

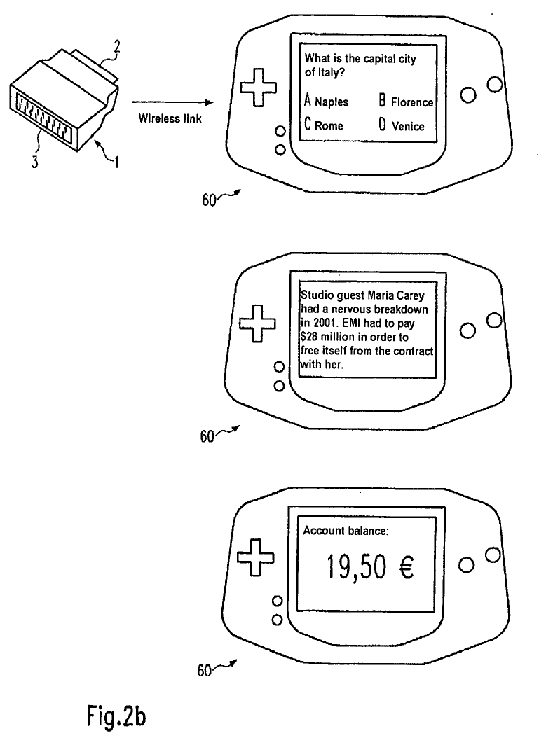

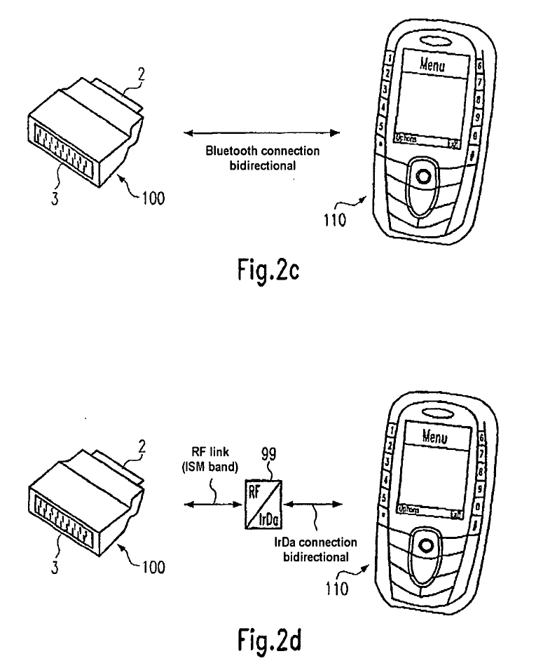

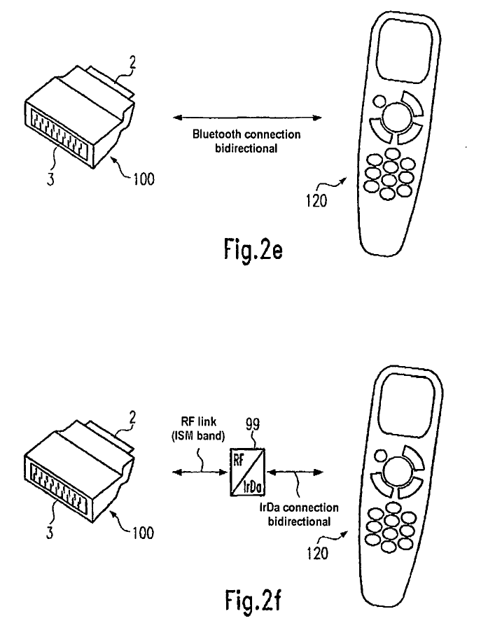

A first exemplary embodiment of the present invention will now be explained in more detail with reference to FIG. 2a. The system according to the invention for providing a transmission channel in parallel with the television transmission essentially comprises two components, namely a peripheral device 1, which is preferably formed as a plug-in module, and a receiver device 60. The plug-in module 1 has a compact housing, on one side of which a plug-in section 2 is formed and on the opposite side of which a socket section 3 is formed. The plug-in section 2 and the socket section 3 are preferably formed according to the SCART standard, so that the plug-in section 2 essentially represents a SCART connector from a mechanical and electrical standpoint and the socket section 3 essentially represents a SCART socket from a mechanical and electrical standpoint. The plug-in module 1 is preferably formed in essentially transparent fashion. This means that the individual pins of the SCART connector 2 are connected through to the corresponding pins of the socket section 3. For the operation of the system according to the invention, the plug-in device 1 is inserted into a SCART connection of a television set (not shown). Such a SCART connection is provided on every television set currently available, to be precise normally on the rear side thereof. The plug-in module 1 is held in its intended position solely by the mechanical coupling between the plug-in section 2 of the plug-in module 1 and the corresponding SCART socket of the television set. In this respect, the plug-in module 1 may also be referred to as a “dongle.”

A SCART connection (SCART=Syndicat Français de Constructeurs d'Appareils Radio et Television), which is likewise known by the designation “Peritel” or “Euroconnector,” is a multipurpose connection for use with home video equipment. Video, audio and control connections are enabled via a standardized 21-pin connection. With regard to a formal description for this, reference is made to the standards CENELEC EN 50049-1:1989 or IEC 933-1. The plug-in module according to the invention is preferably essentially transparent between plug-in section 2 and socket section 3. This means that, in particular, the connection of a video recorder to the television set via the SCART connection can continue to be used despite the use of the plug-in module according to the invention. By way of example, the pins 1, 2, 3, 4, 6, 8, 19, 20 and 21 (ground) might be through-connected in such an application. It goes without saying that, in other applications, more or all pins may be through-connected between the plug-in section 2 and the socket section 3. It should be noted that, according to the invention, the plug-in module 1 may also be formed without a socket section 3. If the plug-in module 1 according to the invention is then connected to a corresponding SCART connection of a television set, the possibility of connecting further peripheral devices, such as a video recorder for example, to the television set via said SCART connection is obviated. The SCART connection of the television set is therefore occupied for the system according to the invention. This is innocuous in many cases, however, for example in a case where the television set is provided with a plurality of SCART connections, so that one of the further SCART connections can simply be used for connecting a video recorder. Likewise, instead of being connected directly to a SCART connection of the television set, the plug-in module 1 according to the invention may also be plugged onto a corresponding SCART connection of a peripheral device that is connected to the television set via the SCART link. By way of example, in an application in which a television set is connected to a video recorder via a SCART link and the video recorder is provided not only with a SCART input but also with a SCART output, the plug-in module 1 according to the invention can be connected to the SCART output of the video recorder since the SCART connection of the television set 1 is looped through via the two SCART connections of the video recorder. Finally, it is also possible for the plug-in module 1 according to the invention to be integrated into the television set as early as during the production of said television set, so that it is no longer necessary for an external plug-in module 1 to be connected in order to implement the system according to the invention. The preferred exemplary embodiment is geared to the SCART interface of the television set, which is preferred because firstly it is very widespread, the television signal currently being displayed on the television set is already present at this interface (pin 19: video output) and, not least, the mechanical properties of the SCART link are virtually predestined for use of a dongle.

With regard to the electronic construction of the plug-in module 1 it should be noted that said plug-in module has a processing device in order to read and separate additional data impressed on the television signal from the currently set channel of the television set. Such additional data can be transmitted for example in the blanking interval in a manner not visible to the television viewer. The additional data may be transmitted together with the television or teletext, for example. Also possible for this purpose are so-called “watermarking” methods, in which additional data are transmitted in the television picture. Another possibility for impressing additional data with respect to the television signal, which is particularly preferred in connection with the present invention, is described in the German patent application No. 101 01 750.2 (mentioned above) entitled “Method for the transmission of data with a television signal.” In this case, a bar code is inserted into the non-visible region of the video signal at the transmitter end, in which the additional data are transmitted in coded fashion together with the television signal. For this purpose, the processing device has a microprocessor with a low power consumption, and also diverse memory devices such as, for example, a RAM and/or a flash memory. An exchangeable battery may be provided, in principle, for the electrical supply of the processing device. However, particular preference is given to a solution which manages without a battery and which draws the energy required for supplying the electrical components from the video output present via pin 19. For this purpose, part of the video signal is tapped off and buffer-stored by means of a capacitor. In this case, use is made of the power taken up from the video output signal preferably only within specific lines of the video frame, for example those teletext lines which have a defined signal level, in order to avoid a black level disturbance of the video signal or some other disturbance which might lead to an impairment of the video recording. In addition to a processing device, the plug-in module according to the invention also has an RF transmitting device. By means of the RF transmitting device, the data read or extracted from the television signal are transmitted to the receiver device 2. Since the electrical power obtained from the video signal is not particularly high, it is preferred for the RF transmitting device to transmit coded pulses to the receiver device. In this case, the “duty cycle” of the transmitted pulses is very low, whereby the requisite power consumption is reduced. In order to prevent an interception of the data transmission from the plug-in module 1 according to the invention to the receiver device 60 according to the invention, the pulses are preferably transmitted in encrypted fashion. The RF transmitting device is preferably operated in one of the free ISM bands (e.g., 868 MHz or 2.4 GHz).

It should be noted that the system according to the invention is suitable for any type of reception of the television signal, that is to say in particular for terrestrial, digital and analog reception and also for reception via cable or satellite. Particularly in the case of the preferred method in accordance with the PCT publication WO 02/25924 A2, however, it is also possible for the additional data also to originate from a different source than a television signal broadcast by a television transmitter. By way of example, it is possible for this purpose to use a data carrier, e.g., a DVD with video information stored thereon, which contains additional data in coded form in the video signal. With these additional data which are tapped off at the television set, e.g., via the SCART interface or inductively, the method on which the present invention is based can also be carried out without a television transmitter, and the additional data can be transmitted to the receiver device, preferably a remote control, for carrying out prize games, betting, voting, etc.

The receiver device 60 is a compact, portable unit having an RF receiving device, a display device and also an input device. By means of the RF receiving device, the data transmitted by the RF transmitting device of the plug-in module are received and decoded and decrypted by a corresponding processing device. The receiver device 60 furthermore has an internal clock which can be updated by time information transmitted by the plug-in module 1. Furthermore, the receiver device 60 has a smart card chip in which electronic cash, or else virtual money, as it were electronic “tokens” or “chips,” has been previously stored. Such a smart card chip has the advantage that all security-critical transactions, e.g., excluding the RF reception control and the control of the display device, with regard to the amount stored on the cash chip, proceed in the chip and are therefore largely inaccessible to external manipulation. The display device is preferably an LCD display with a minimal line number of seven lines. The receiver device 60 preferably has an exchangeable battery for power supply purposes. The size of the receiver device 60 preferably ranges from the size of a credit card through to the size of a PDA. The receiver device 60 according to the invention may also be formed as an additional module with respect to a PDA and be connectable thereto.

The receiving device 60 having a smart card chip preferably has three operating modes (also cf., FIG. 2b). The first operating mode (cf., upper part of FIG. 2b) is a question-answer operating mode, in which, on the basis of the data transmitted, in particular in a wireless manner, from the plug-in module or adapter 1 connected to a television set, questions with various possible answers are presented on the display device. This can also readily be discerned from the illustration in FIG. 2a. By way of example, the question asks what is the capital city of Italy (cf., upper part of FIG. 2b). A Naples, B Florence, C Rome, and D Venice are predetermined as possible answers. By means of the input device, the user can then input an answer into the receiver device 60 by pressing the corresponding key. The correct answer has likewise been transmitted to the receiver device 60 by the plug-in module 1, so that an evaluation of the user's answer can be carried out internally in the smart card chip of the receiver device 60. Preferably, a multiplicity of such questions are transmitted to the receiver device and the answer input in each case is evaluated. If, by way of example, a sufficient portion or all of the answers are correct, this is registered as a “win” in the electronic cash chip. This can also be indicated to the user and a coded audio signal may furthermore be generated, in which case the user can identify himself as a winner, e.g., for instigating a “payout,” by calling a specific telephone number the audio signal via a loudspeaker provided in the receiver device 60, by remote transmission of the audio signal. In principle, however, alternative realizations are also conceivable here. By way of example, a code suitable for identifying the user by telephone may be displayed on the display device of the receiver device 60. Likewise, a win can be credited to a user through the electronic cash capability directly in the receiver device 60. Furthermore, participation in a prize game can be debited directly from the smart card electronic cash chip. The stored electronic cash can be transmitted from the receiver device to other devices, further receiver devices 60, PCs, cash cards, etc. via a limited number of TANs. An infrared receiver pair or an electrical interface (USB) may also be used for this purpose. The cash stored in the receiver device 60 may be obtained from a plurality of sources by inputting code sequences which are obtained for example from the Internet or from a scratch card, credit cards, or the like. In principle, the invention also encompasses downloading cash or cash equivalents by means of the television signal. In the second operating mode (cf., middle part of FIG. 2b), program-accompanying text and picture information is displayed on the display device of the receiver device 60. By way of example, this may be a teletext page which corresponds to the current program and is overwritten in each case briefly by current news. In the middle part of FIG. 2b, the display in this case indicates that “Studio guest Maria Carey had a nervous breakdown in 2001. EMI had to pay her $28 million in order to free itself from the contract with her.” In a third operating mode (cf., lower part of FIG. 2b), the account balance of the amount of cash or cash equivalent stored in the receiver device 60 (“Account balance: ∈ 19.50”) is displayed or altered, i.e., for example reloaded.

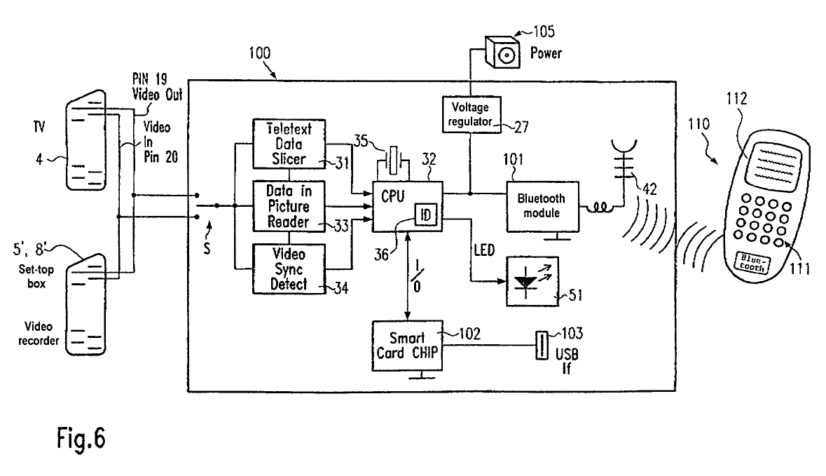

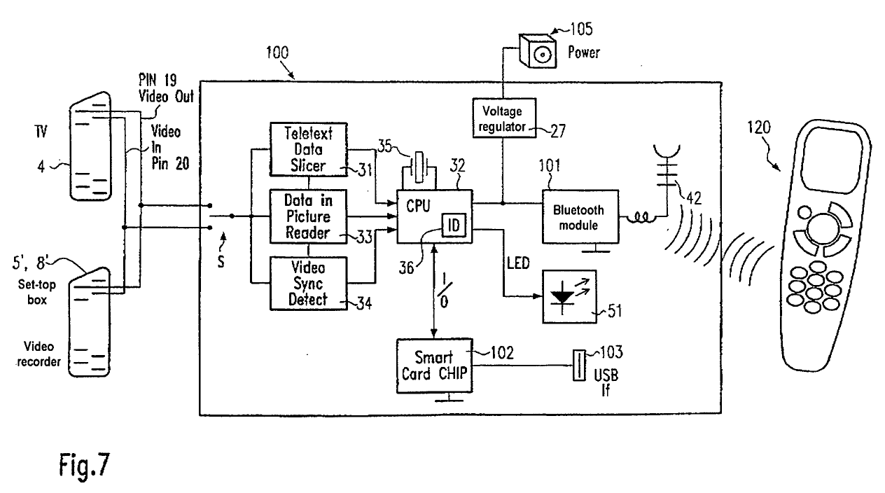

FIGS. 2c and 2d show exemplary embodiments which differ in comparison with the exemplary embodiments described above in conjunction with FIGS. 2a and 2b primarily by the fact that the receiver device does not represent dedicated hardware, but rather is a mobile telephone. Correspondingly, FIGS. 2e and 2f show a particularly preferred variant of the invention which likewise does not use dedicated hardware as the receiver device, but rather a remote control for a television set with a corresponding additional functionality. For these exemplary embodiments, attention is also drawn to the description below of FIG. 6 (receiver device is the mobile telephone 110) and FIG. 7 (receiver device is the remote control 120).

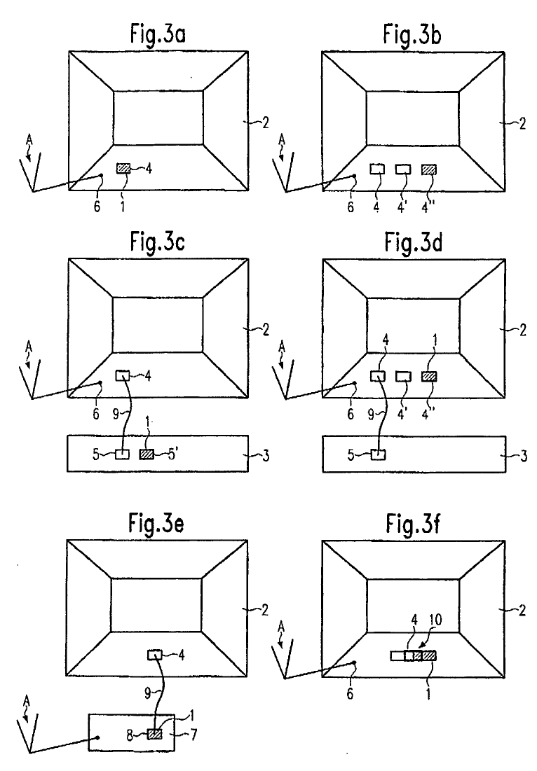

Different variants of the connection of the plug-in module 1 according to the invention to a television set 2 or peripheral devices connected thereto such as, e.g., a video recorder 3, can be gathered from FIGS. 3a to 3f. FIG. 3a illustrates the rear side of a television set 2 (through schematic indication of the picture 2), on which a SCART connection 4 is formed. The television signal passes from an antenna A via a coaxial cable to a corresponding input socket 6 and is also present at the SCART socket 4 as a result of corresponding internal wiring in the television set 2. The device 1 according to the invention is inserted into the SCART socket 4, this being shown by the hatching in FIG. 3a. It should be noted that instead of reception of the television signal via an antenna A, for example a room or house antenna, reception via cable or satellite is also possible. It goes without saying that the present invention can also be applied to digital television. In contrast to the illustration in FIG. 3a, FIG. 3b shows a television set 2 provided with a multiplicity of SCART connections or sockets 4, 4′ and 4″. The plug-in module according to the invention is inserted into the SCART socket 4″, for example, the two remaining SCART sockets 4 and 4′ being available for the connection of further peripheral devices. The illustration reveals that, in the case of the application in accordance with FIG. 3a, it is particularly advantageous if the plug-in module 1 according to the invention has both a plug-in section and a socket section with transparent connection in order that the only SCART connection 4 of the television set 2 is not occupied by the plug-in module 1 according to the invention. In an application in accordance with FIG. 3b this is substantially less critical since further socket locations 4, 4′ remain even with the use of the plug-in module 1 according to the invention. In accordance with FIG. 3b, therefore, it would also be possible for a socket section not to be formed on the plug-in module according to the invention, so that the plug-in module 1 according to the invention represents a termination.

FIGS. 3c and 3d schematically illustrate two further connection variants of the plug-in module 1 according to the invention to a television set 2 and, respectively, to a video recorder 3 connected thereto. The illustration of FIG. 3c proceeds from a television set 2 in accordance with FIG. 3a. In contrast thereto, the television set 2 is connected to the video recorder 3, to put it more precisely the SCART connection 4 of the television set 2 is connected to a SCART connection 5 of the video recorder 3 via a SCART cable 9. In addition to the SCART connection 5, the video recorder 3 has a further SCART connection 5′, at which the plug-in module 1 according to the invention is inserted. In accordance with FIG. 3d, in the case of a television set 2 having a plurality of SCART connections 4, 4′ and 4″ (also cf., FIG. 2b), the SCART connection 4 is used for connection of the video recorder 3 via the SCART cable 9, in which case the plug-in module according to the invention can be connected to one of the two free SCART connections 4′, 4″. A connection of the plug-in module at 4″ is shown in the drawing.

FIG. 3e illustrates a case in which the television signal from the antenna A is connected to the SCART connection 4 of the television set 2 via a set-top box 7 (having only one SCART connection 8) via a SCART cable 9. In this application, the plug-in module 1 according to the invention is connected to the SCART connection 8 of the set-top box 7. The plug-in module 1 formed in transparent fashion permits the set-top box 7 to be connected to the television set 2. FIG. 3f schematically shows a television set 2 having only one SCART connection 4, to which is connected an accessory unit 10 having a SCART connector for connection to the SCART socket 4 of the television set 2, and furthermore two socket sections that essentially serve for providing two SCART connections from the one SCART connection 4 of the television set 2. The illustration of FIG. 3f reveals that the plug-in module 1 according to the invention is inserted at one of these.

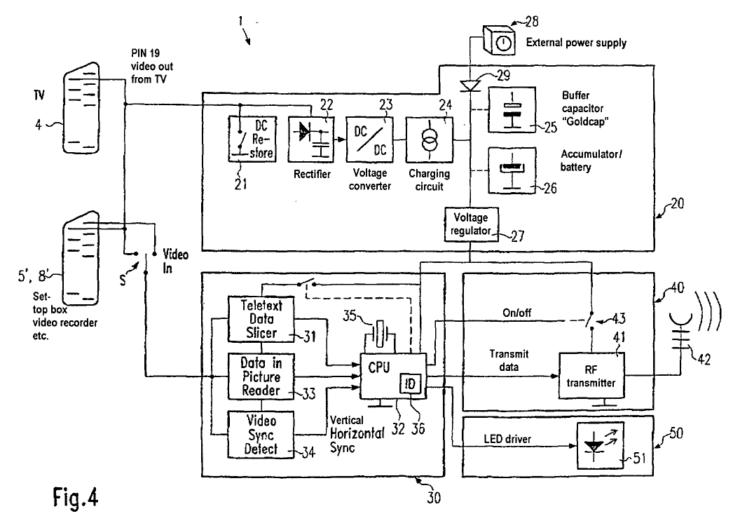

It is evident in particular from a combined consideration of FIGS. 3a to 3f that the plug-in module 1 according to the invention can be inserted directly at a SCART connection of a television set 2. In addition, however, it is also possible to connect the plug-in module 1 according to the invention to a further peripheral device for the television set 2. The variants illustrated comprise, as further peripheral devices or units of this type, a video recorder 3 (cf., FIG. 3c), a set-top box 7 (cf., FIG. 3e) or a switching selector 9 (cf., FIG. 3f). In principle, the invention also encompasses other peripheral devices or units. If the plug-in device 1 according to the invention is not connected directly to a SCART connection 4 of the television set 2, it is preferred, in principle, for the video signal to be tapped off from a different pin than pin 19, namely from pin 20, which is the video output of the set-top box 7 or of the video recorder 3 and otherwise corresponds to the video input of the SCART cable. In order to take account of these different requirements made of the wiring, the plug-in device 1 according to the invention preferably has a switch S (not illustrated in FIGS. 3a to 3f) that is switched over depending on the type of connection of the plug-in device 1 according to the invention. In this respect, reference is made to the illustration of FIGS. 4 and 6 and the associated description.

FIG. 4 schematically shows the construction of the plug-in module 1 according to the invention in the form of a block diagram. In this case, the plug-in module 1 is inserted either into a SCART socket 4 of a television set 2 or a SCART socket 5′ or 8′ of a peripheral device, e.g., a video recorder or a set-top box, etc., provided for connection to the television set 2. In both applications of this type, the energy required for supplying the electrical components of the plug-in module 1 and also the additional data are obtained from the video signal via pin 19 of the SCART sockets 4 or pin 20 of the SCART sockets 5′, 8′. Depending on the possible use of the plug-in module 1, the switch S is switched over for this purpose (in this respect, also see the following description of the extraction of the additional data from the television or video signal). The video signal is supplied to a voltage generating device 20. The voltage generating device 20 has a DC restore circuit 21, which is necessary for the case where the television set has a capacitor-coupled video output. The DC restore circuit 21 has an electronic switch in the form of a clamping circuit which provides for a defined DC voltage level. The video signal processed in this way is converted into a DC voltage, having a voltage value of minimally approximately 0.7 to 0.8 volt, by means of a peak rectifier such as, e.g., a diode having a low forward voltage, for example a Schottky diode, or a rectifier cascade. Downstream of the rectifier circuit 22 is a voltage converter 23, which increases the voltage supplied by the output of the rectifier 22, to be precise to such a voltage value which lies somewhat above the supply voltage (typically 3 to 5 volts) required for the operation of the further electrical components such as, e.g., the CPU, the RF transmitter, etc., used in the plug-in module 1. On account of the limited loading capacity of the rectifier 22 connected upstream, the output current of the voltage converter 23 is relatively low. By means of a charging circuit 24, which is a current source or a resistor, for example, an energy buffer is continuously charged with a small current until a sufficient final charging voltage has been reached. The store for the electrical energy or energy buffer may be for example a capacitor having a high capacitance, e.g., a so-called “Goldcap” capacitor 25 from Panasonic. As an alternative or in addition thereto, it is also possible to use a rechargeable battery or accumulator 26 as the energy buffer. The capacitor 25 or the accumulator 26 is charged to a final charging voltage that lies somewhat above the operating voltage. The advantage of such an energy buffer consists in the fact that the latter can briefly supply a substantially greater current than the output of the voltage converter 23. As an alternative or in addition to the electrical supply via pin 19 of the video output signal, it is also possible to use an external power supply, e.g., via a plug-in power supply unit. This is designated schematically by 28. In this case, the rectification of the external AC voltage is produced by means of a diode 29. A voltage regulator 27 is provided for regulating the output of the energy buffer 25 or 26 down to the desired operating voltage of the further electrical components of the plug-in module 1 according to the invention.

The regulated voltage generated by the voltage generating device 20 serves for supplying a processing device 30, a transmission device 40 and a display device 50. It should be noted that the processing device 30, the transmission device 40 and the display device 50 can be isolated from the power supply. The low target current consumption required for feeding from the video out signal (pin 19) can be guaranteed in this way.

The processing device 30 processes an input signal which is tapped off at pin 19 (video out of the television set) in the case of connecting the plug-in module 1 according to the invention to a television set. If the plug-in module 1 according to the invention is connected to a SCART socket of a set-top box or a video recorder, the input signal for the processing device 30 is tapped off from the video in pin 20, which corresponds to the video out connection of the set-top box or the video recorder. In order to provide for a correct electrical connection given the two different types of connections of the plug-in module 1 according to the invention, a switch S is provided on the outside of the housing of said module, which switch enables, in one respective switch position, a correct connection of pin 20 of a connection socket 5′, 8′ of a set-top box or a video recorder and, in the second switch position, a connection from pin 19 of a SCART socket 4 of a television set to the processing device 30. The processing device 30 has a teletext data receiver or slicer 31 which evaluates the teletext lines output at the video out pin if relevant additional data are transmitted via teletext. Otherwise, the teletext data receiver 31 may also be omitted. The data read are forwarded to a central processing unit, which is preferably realized as an integrated circuit in the form of a CPU 32. Furthermore, the input signal is fed from a “data in picture reader” module 33, this circuit part being able to read data which are transmitted in the video picture. In this respect, reference is also made to German patent application 101 0 1 750.2 mentioned previously. Finally, the input signal is fed into a “video sync detect” module 34. This circuit part can identify the vertical and horizontal video sync signals and, if appropriate, turn on the CPU 32 by means of an interrupt. This is advantageous for the power management since the reading of data to be received is necessary only at specific times with regard to the video sync signal. The CPU 32 has an internal power management and is in a power saving operating mode most of the time. A permanently active clock generator, which is realized for example by a crystal 35 having a low power consumption and a frequency of, e.g., 32 kHz, ensures a periodic wake-up of the CPU 32. After the wake-up, the CPU 32 activates the modules 31, 33 and 34 and, in the case where corresponding additional data have been identified in the video signal, transmits them to an RF transmitter 41. Identification data stored in the ID memory of the CPU 32 are concomitantly transmitted in this case. The RF transmitter 41 transmits the data via an antenna 42 to the receiver device 60 shown in greater detail in FIG. 4. Furthermore, a switch 43, preferably realized as a transistor, is provided, which is arranged between the voltage regulator 27 and the RF transmitter 41 and which is correspondingly driven by the CPU 32. This results in particularly good power management since the RF transmitter 41, if the latter is not required, can be isolated from the supply—in a manner driven by the CPU 32. The additional data impressed on the control signal are thus transmitted in pulse-coded form (RF) from the plug-in module 1 according to the invention to the receiver device 60. The data may likewise be transmitted in encrypted fashion in this case. Furthermore, it is particularly preferred for the data transmission to be effected in authenticated fashion. This means that the receiver device 60 can recognize that the data transmitted by the plug-in module 1 are actually intended for it. This may be done for example by an initialization of the receiver device 60 at the plug-in module 1 according to the invention. This is particularly preferred because operation by an authorized user has to be ensured in the case of a radio link between the plug-in module 1 and the receiver device 60; it is undesirable in this context if, by way of example, a further plug-in module used in spatial proximity to the plug-in module 1 emits corresponding signals that would then be used incorrectly by the receiver device 60 for further processing. The RF transmitter 41 can preferably send data in one of the free ISM bands for short range devices, e.g., 433 MHz, 868 MHz, 2.4 GHz, etc. The transmission power suffices for a transmission up to a minimum range of approximately 5 to approximately 10 meters.

Furthermore, the CPU 32, after the wake-up thereof, drives a display device 50 preferably having one or more light emitting diodes 51. By way of example, short flashing of the LED 51 can be used to indicate an operating state indicating a data emission from the plug-in module 1 to the receiver device 60. After the data emission of the CPU 32, the latter switches back to the power saving operating mode until the CPU 32 is woken up again by the clock generator 35.

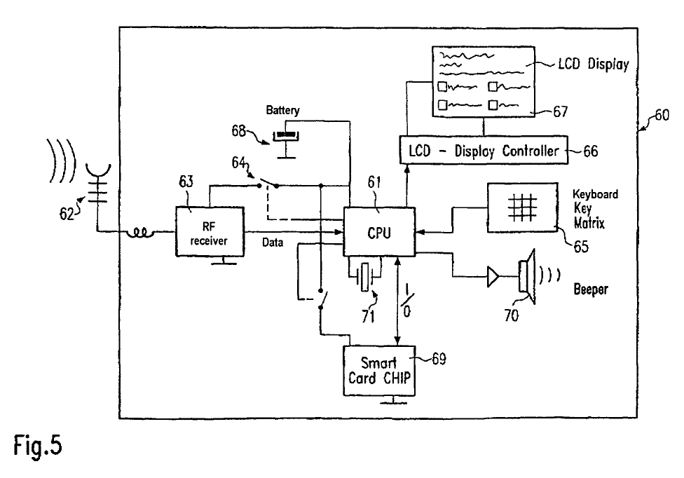

An exemplary embodiment of the receiver device 60 according to the invention is explained in more detail below with reference to the schematic diagram of FIG. 5. The receiver device 60 has a central processing unit, preferably realized as CPU 61. In accordance with the CPU 32 of the processing device 30 of the plug-in module 1 according to the invention, the CPU 61 likewise has an internal power management and is in a power saving operating mode most of the time. A permanently active clock generator, preferably realized as a low-power crystal 71 having a frequency of, e.g., 32 kHz, provides, in conjunction with a timer integrated in the CPU 61, for a periodic wake-up of the CPU 61 in accordance with specific data transmission time slots. It is ensured in this case that the CPU 61 is woken up at least at the times in which a signal transmission is effected from the plug-in module 1 to the receiver device 60. The data transmitted from the plug-in module 1 via the latter's RF transmitter 41 and antenna 42 are received by an antenna 62 and supplied to the CPU 61 via an RF receiver 63. The RF receiver can receive data via radiofrequency preferably in one of the free ISM bands for short range devices, e.g., 433 MHz, 858 MHz, 2.4 GHz. The RF transmitter 41 and the antenna 42 of the plug-in module 1 are coordinated in terms of frequency with the antenna 62 and the RF receiver 63 and the receiver device 60. The sensitivity of the unit formed from the antenna 62 and the RF receiver 63 suffices for reliable reception over a minimum distance of 5 to 10 meters from the plug-in module 1 according to the invention. As is indicated schematically in FIG. 4 by a switch 64 driven by the CPU 61, the RF receiver is turned on by the CPU only at specific time slots in order to save power. The CPU 61 can also be woken up by a user effecting inputting via a keyboard 65. The keyboard 65 preferably has a keyboard matrix such as is known, e.g., in the case of an infrared remote control. Furthermore, the CPU 61 can display data on a display device 67, which is preferably an LCD display, via an LCD display controller 66. The LCD controller is for example a standard display controller, e.g., for a dot matrix or 16-segment display, for outputting text. For electrical supply purposes, an exchangeable battery 68 is preferably provided in the receiver device 60. The battery 68 supplies the CPU 61, the RF receiver 63 and a smart card chip 69 with electrical energy. In this case, the battery 68 may also be a rechargeable battery or accumulator. As an alternative or in addition thereto, the power supply may also be effected from a power supply unit (not shown). It should be noted that all circuit parts including the CPU 61 can be isolated from the power supply. A maximum lifetime of the battery 68 can be ensured in this way. The smart card chip 69 is connected to the CPU 61 via an I/O interface. Instead of the smart card chip 69, the receiver device 60 may also be provided with a smart card read/write unit, so that a user correspondingly uses his smart card for operating the receiver device 60. The CPU 61 likewise drives a tone generating device or beeper 70 with a loudspeaker, special software being provided in the CPU 61 for this purpose. The tone generating device 70 may output, inter alia, tones that are coded in accordance with the pulse dialing method for an acoustic transmission of data, e.g., information about one or more correct answers to questions, via a telephone connection (in this respect, also see the schematic overview of FIG. 1). For this purpose, by way of example, the beeper 70 is held against a telephone receiver. However, other transmission paths for remote data transmission of data stored in the receiver device 60 are also possible. Examples thereof are SMS dispatch, WLAN, etc.

A cash card functionality is advantageously integrated in the receiver device 60, to be precise for example in the form of a reader for cash cards or so-called smart cards. By virtue of the reader for cash cards, it is possible to achieve for the user an extended functionality of the receiver device 60, in addition for example to the design as a remote control, in that the user can check the account balance of his cash card. Furthermore, it is also possible to form a payment terminal in the receiver device 60, in particular with a writing device for the cash card, in order to realize in a simple manner for chargeable services such as, e.g., prize games, a simple and secure possibility of paying out prizes and paying in charges.

With regard to the processing of the data that are transmitted from the plug-in module 1 according to the invention to the receiver device 60, a division of work takes place between the CPU 61 and the smart card chip 69. In this case, the CPU 61 carries out normal operations for controlling the various components of the receiver device 60 such as, e.g., the RF receiver 63, the LCD display controller 66, etc. The smart card chip 69 is provided for processing security-critical data. By way of example, the latter may comprise the evaluation of answers which the user input via the keyboard 65, and the registering of a win in response thereto. On account of the fact that a smart card chip is particularly difficult to manipulate, this type of division of tasks is particularly preferred.

During operation, the CPU 61, after wake-up, activates the RF receiver 63 and receives data transmitted by the plug-in module 1 via said RF receiver if said data are transmitted. Furthermore, the CPU 61 refreshes the LCD display 67, if appropriate. The received data are typically encrypted and are forwarded at least in part from the CPU 61 to the smart card chip 69 for decryption and authentication. As has already been mentioned in the introduction, examples of data which data to be transmitted from the original source (television transmitter) to a user via the parallel communication channel provided by the invention are for example text data (questions and answers). In this case, the data are not intended to be made accessible to a user or are intended to be made accessible only after specific correct inputs via the keyboard 65. By way of example, for this purpose, the questions are identified by the smart card chip 69 and presented on the LCD display 67 via the CPU 61. The answers which the user inputs via the keyboard 65 are transmitted from the CPU 61 to the smart card chip 69 for their verification or falsification. A result of the user's inputs is then output on the LCD display 67 from the smart card chip 69 via the CPU 61. In this case, the smart card chip 69 performs in particular the decryption of the data and also the authentication, not only the data and the data transmission being authenticated but also in particular the time, which is transmitted together with the television signal to a user's television set, and is then transmitted further to the receiver device 60, in order largely to preclude manipulations. In this case, it is possible in particular to transmit an absolute and also a relative time to the application running in the smart card chip 69.

In the case of the exemplary embodiment shown in FIG. 5, the receiver device 60 is a dedicated hardware which cooperates with the plug-in module 1 according to the invention in order to open up the separate data channel according to the invention to a television viewer. It is clear to a person skilled in the art that instead of the receiver device 60, it is also possible to have recourse to conventional devices provided in particular with an input/output functionality, such as keyboard and display, for example. Examples of such devices are a personal digital assistant (PDA), a mobile telephone or a remote control. In the exemplary embodiment in which a PDA is used as the receiver device, for example, the functionality of the receiver device 60 is obtained by providing an additional module according to the invention with respect to the PDA, said additional module having in particular the RF receiver 63 and the smart card chip 69.

FIG. 6 schematically illustrates a further exemplary embodiment of the plug-in module or adapter 100 according to the invention. In this respect, attention shall also be drawn to FIG. 2c. The text below will primarily discuss in more detail the differences between the exemplary embodiment shown in FIG. 6 and those exemplary embodiments in accordance with FIGS. 2a and 4, in order to avoid repetition. Instead of the RF transmitter 41, the plug-in module 100 shown in FIG. 6 has a Bluetooth module or piconet module 101, which is able to interchange bidirectionally data, in particular encrypted by means of the Bluetooth standard, with a mobile telephone, PDA and the like 110, which is likewise provided with a Bluetooth interface. The mobile telephone 110 furthermore has a keyboard 111 and a display 112, so that the mobile telephone 110 represents a receiver device, which according to the invention cooperates with the plug-in module 100. The smart card chip 102 which is preferred for security-critical applications is arranged in the plug-in module 100 in accordance with the exemplary embodiment shown in FIG. 6. Furthermore, the plug-in module 100 has a USB interface indicated at 103. In particular on account of the Bluetooth module 101, a battery or a power supply system connection 105 is preferred for supplying energy to the plug-in module 100. The particular advantage of the exemplary embodiment shown in FIG. 6 consists in the fact that no dedicated hardware is required for the receiver device, and a conventional mobile telephone with a Bluetooth interface can be used. Therefore, the present invention enables an additional data channel from a television transmitter to a television viewer, more precisely to the latter's mobile telephone 110, in which case no telephone charges whatsoever arise for the data transmission and millions of television viewers can be contacted simultaneously.

In a further variant of the present invention (FIG. 2d) already explained in the introduction, the data transmission is in this case preferably effected between the plug-in module 100 and the mobile telephone, PDA and the like 110 bidirectionally via a first transmission link, representing an RF link, from the plug-in module 100 to an RF/IrDa repeater 99. A connection from the RF/IrDa repeater 99 to the mobile telephone 110 is ensured on the second transmission link, which functions according to the IrDa standard. In the RF/IrDa repeater 99, a conversion from RF to IrDa and vice versa is effected. From a structural standpoint, the RF/IrDa repeater 99 can be integrated in a receptacle element (cradle) for the mobile telephone 110 and the like, whereby the requisite spatial proximity can also be ensured at the same time. The particular advantage of the exemplary embodiment shown in FIG. 2d (combined RF-IrDa connection with interposed repeater or relay, heterogeneous transmission link) by comparison with that shown in FIG. 2c (bidirectional Bluetooth connection, homogeneous transmission link) consists in the fact that the mobile telephone 110 or the like can be addressed substantially more easily via the IrDa interface and can be programmed for purposes of the present invention. Applications (e.g., games) and data can also be loaded into the mobile telephone 110 via the IrDa connection. The mobile telephone 110 and the like is Java-enabled (J2ME), so that corresponding applications can be transmitted thereto in a simple manner and be executed there.

Summarizing the various aspects of the invention, a peripheral device for a television set comprises an interface at which the television signal can be tapped off, wherein the peripheral device has a plug-in device for connecting the peripheral device to the interface of the television set or a corresponding interface of a further peripheral unit connected to the television set, at least one portion of the television signal being present at the one interface or the further interface being processed by a processing device of the peripheral device, and the data being supplied by the processing device being transmitted to a receiver device via a transmission device of the peripheral device. The television program currently set on the television set can be tapped off at the interface. The interface can be a SCART connection of the television set or a further peripheral device connected thereto via the SCART connection of the television set.

The processing device can extract impressed additional data in addition to the program signal from the television signal and condition them for the transmission. The impressed additional data can have the channel number of the set television transmitter and/or the current time of day, which can be encrypted. The transmission of the data by the transmission device can be exclusively unidirectional and/or effected essentially simultaneously, in particular in program-accompanying fashion, with respect to the broadcast program signal to the receiver device. The peripheral device can have a socket device, such as a SCART socket, in which at least one further peripheral unit, such as a video recorder, for the television set can be connected, the peripheral device being essentially transparent between plug-in and socket device. For example, the peripheral device can be formed as a plug-in module with a plug section and a socket section. A portion of the electrical energy of the television signal can be used to supply electricity to the peripheral device.

The peripheral device includes a transmission device, such as an RF transmitter, which transmits the data supplied by the processing device as coded pulses in encrypted and/or authenticated form to a receiver device. The receiver device can be a portable unit comprising a display device for displaying data, an input device for inputting data and a processing direction. The receiver device can have an electronic cash device, an amount being debited in a case in which the evaluation reveals that the data input by the user do not correspond to the associated data of the second data set.

The processing device of the peripheral device extracts from the television signal data which have two different sets of data, individual data of the two data sets being assigned to one another, assigned data of the two data sets being transmitted to the receiver device by the transmission device, and at least initially any data of the first data set being displayed on the display device of the receiver device, and the second group of data being used for the evaluation of data input by a user via the input device of the receiver device by the processing device of the receiver device.

According to another aspect of the invention, a receiver device for receiving data transmitted by the aforementioned peripheral device can be a portable unit comprising a display device for displaying data, an input device for inputting data and a processing direction. The receiver device can include a loudspeaker via which a processing step that has taken place in the receiver device is acknowledged acoustically and/or data generated by the processing device are transmitted remotely via a telephone line. The receiver device can be configured to require entry of an authentication code to operate. The processing device of the receiver device can be formed as a smart card chip.

In accordance with yet another aspect of the invention, a plug-in module is configured to be inserted into an interface of a television set or into an interface of a peripheral device connected thereto, the inserted plug-in module having a device for separating additional data impressed on the television signal present at the interface from said television signal, and the plug-in module furthermore having a transmission device for transmitting the additional data to a portable receiver device. The plug-in module receives additional data corresponding to the program signal currently being displayed on the screen of the television set via the interface. The transmission of the additional data can be effected essentially simultaneously with the display of the broadcast program signal on the television set. The additional data impressed on the television signal can accompany the program. In the event of a channel switchover of the television set from a previous channel to a current channel, the additional data of the current channel are separated and transmitted after the switchover by the plug-in module via the interface.

The interface can be formed externally on the television set and can be a SCART interface of a television set or of a peripheral device. Thus, for example, the additional data can be received via pin 19 of the SCART interface of a television set or video recorder or pin 20 of the SCART interface of a set-top box.

The portable receiver device has a display device in which the additional data can be displayed, in particular essentially simultaneously with the program signal displayed on the television set. The portable receiver device can be a mobile telephone, a personal digital assistant (PDA), a remote control for a television set, a video recorder, a DVD player or the like.

The plug-in module can have a plug section and a socket section, the plug section and a socket section being arranged such that they are essentially opposite, and the plug-in module being formed such that it is essentially transparent between the plug section and a socket section.

The transmission of the additional data to the portable receiver device can be effected in accordance with the Bluetooth standard, the plug-in module and the receiver device having a corresponding Bluetooth interface. Another option is that the transmission of the additional data to the portable receiver device can be effected in accordance with the IrDa standard at least via part of the transmission link, an IrDa repeater being provided in the transmission link in order to receive the data from the plug-in module and to transmit them to the receiver device having an IrDa interface.

The invention further encompasses a system comprising a peripheral device or a plug-in module and a receiver device as described above.

According to still another aspect of the invention, a method provides a transmission channel in parallel with a television transmission via a plug-in module, the plug-in module being insertable into an interface of a television set or in an interface of a peripheral device connected thereto, the inserted plug-in module having a device for separating additional data impressed on the television signal present at the interface from said television signal, and the plug-in module furthermore having a transmission device for transmitting the additional data to a portable receiver device.

Further, a peripheral device for a television and/or radio set comprises an interface at which the television and/or radio signal can be tapped off, wherein the peripheral device has a plug-in device for connecting the peripheral device to the interface of the television and/or radio set or a corresponding interface of a further peripheral device connected to the television and/or radio set, at least one portion of the television and/or radio signal present at said one interface or the further interface being processed by a processing device of the peripheral device, and the data supplied by the processing device being transmitted to a receiver device via a transmission device of the peripheral device.

The invention has been explained in more detail above on the basis of preferred embodiments thereof. However, it is obvious to a person skilled in the art that various adaptations and modifications can be made without departing from the concept on which the invention is based. In particular, it should be noted that the present invention is not restricted to use in connection with a television signal. Instead of the television signal, it is also possible in particular to use some other broadcast signal, for example a radio signal, with additional data preferably impressed in the audio signal, in connection with a radio set instead of a television apparatus.

What is claimed is:

1. A peripheral device for a television set having a first interface at which the television signal can be tapped off, comprising:
a plug-in device for connecting the peripheral device to the first interface of the television set or to a corresponding second interface of a further peripheral unit connected to the television set;
a processing device configured to process at least a portion of the television signal present at the first or second interface of the peripheral device; and
a transmission device configured to transmit data supplied by the processing device to a receiver device.

2. The peripheral device of 1, wherein the processing device extracts impressed additional data in addition to the program signal from the television signal and conditions the impressed additional data for transmission.

3. The peripheral device of claim 2, wherein the impressed additional data includes an encrypted channel number of the television set and/or an encrypted current time of day.

4. The peripheral device of claim 1, wherein the transmission device transmits data to the receiver device exclusively unidirectional and/or essentially simultaneously with respect to a broadcast program signal.

5. The peripheral device of claim 1, further comprising:
a socket device in which at least one further peripheral unit for the television set can be connected, the peripheral device being essentially transparent between the plug-in device and the socket device.

6. The peripheral device of claim 5, wherein the socket device is a SCART socket.

7. The peripheral device of claim 5, wherein the further peripheral unit comprises a video recorder, DVD player, or a set-top box.

8. The peripheral device of claim 1, wherein the peripheral device is configured as a plug-in module with a plug section and a socket section.

9. The peripheral device of claim 1, wherein the, peripheral device draws a portion of the electrical energy of the television signal present at the first or second interface for an electrical supply.

10. The peripheral device of claim 1, wherein the transmission device comprises an RF transmitter which transmits the data supplied by the processing device as coded pulses in encrypted and/or authenticated form to the receiver device.

11. The peripheral device of claim 1, wherein a television program currently set on the television set is tapped off at the first interface.

12. The peripheral device of claim 1, wherein the plug-in device is a SCART connector.

13. The peripheral device of claim 1, wherein the processing device extracts from the television signal data having two different sets of data, individual data of the two data sets being assigned to one another, assigned data of the two data sets being transmitted to the receiver device by the transmission device, and at least initially any data of the first data set being displayed on the display device of the receiver device, the second group of data including evaluation data for evaluating data input into the receiver device by a user.

14. A portable receiver device for receiving data transmitted by the peripheral device of claim 1, comprising:
a display device for displaying data;
an input device for inputting data; and
a processing device.

15. The receiver device of claim 14, wherein the receiver device receives a first set of data for display on the display device, and receives input data from a user via the input device in response to display of the first set of data, and evaluation data for evaluating whether the input data is correct.

16. The receiver of claim 15, further comprising:
an electronic cash device configured to debited an amount from a current balance in response to receiving incorrect input data.

17. The receiver device of claim 14, further comprising:
a loudspeaker configured to generate an acoustic signal in response to an operation of the receiver device is acknowledged.

18. The receiver device of claim 14, wherein the receiver device is required to receive an authentication code to initiate operation.

19. The receiver device of claim 14, wherein the processing device comprises a smart card chip.

20. The receiver device of claim 14, wherein the receiver device comprises a remote control for a television set, a video recorder, DVD player, or a set-top box.

21. The receiver device of claim 14, further comprising:
a terminal for reading and/or writing to smart cards.

22. The receiver device of claim 15, further comprising:
a charging station into which the receiver device can be inserted for charging a rechargeable battery, the charging station having an indicator that is actuated in response to receipt of the first set of data and the evaluation data.

23. A plug-in module configured to be inserted into an interface of a television set or into an interface of a peripheral unit connected thereto, comprising:
a device for separating additional data impressed on a television signal present at the interface from the television signal; and
a transmission device for transmitting the additional data to a portable receiver device.

24. The plug-in module of claim 23, wherein transmission of the additional data is effected essentially simultaneously with display of a broadcast program signal on the television set.

25. The plug-in module of claim 23, wherein the plug-in module receives additional data corresponding to the program signal currently being displayed on a screen of the television set via the interface.

26. The plug-in module of claim 23, wherein, in response to a channel switchover of the television set from a previous channel to a current channel, the additional data of a current channel is separated and transmitted after the channel switchover by the plug-in module via the interface.

27. The plug-in module of claim 23, wherein the interface is disposed externally on the television set.

28. The plug-in module of claim 23, wherein the interface is a SCART interface of a television set or of a peripheral device.

29. The plug-in module of claim 28, wherein the additional data is received via pin 19 of the SCART interface of a television set or pin 20 of the SCART interface of the peripheral device.

30. The plug-in module of claim 29, further comprising an external switch for switching between pin 19 and pin 20 of the SCART interface.

31. The plug-in module of claim 23, further comprising:
a plug section and a socket section, the plug section and a socket section being arranged such that they are essentially opposite, and the plug-in module being formed such that it is essentially transparent between the plug section and a socket section.

32. The plug-in module of claim 23, wherein the transmission device transmits the additional data to the portable receiver device in accordance with the Bluetooth standard, the plug-in module and the portable receiver device having a corresponding Bluetooth interface.

33. The plug-in module of claim 23, wherein the transmission device transmits the additional data to the portable receiver device in accordance with the IrDa standard at least via part of the transmission link, an IrDa repeater being provided in the transmission link in order to receive the data from the plug-in module and to transmit the data to the receiver device having an IrDa interface.

34. The plug-in module of claim 23, further comprising a SCART connector for mechanically coupling the plug-in module to a SCART socket of the television set or a further peripheral unit connected thereto.

35. The plug-in module of claim 23, wherein the additional data impressed on the television signal is contained and coded in a video signal of the television signal.

36. A method for providing a transmission channel in parallel with a television transmission via a plug-in module, comprising:
inserting the plug-in module into an interface of a television set or into an interface of a peripheral device connected to the television set;
providing the plug-in module with a device for separating additional data impressed on a television signal present at the interface from the television signal; and
providing the plug-in module with a transmission device for transmitting the additional data to a portable receiver device.

37. The method of claim 36, wherein the additional data impressed on the television signal is contained and coded in a video signal, audio signal, and/or in a blanking interval of the television signal.
